(19) United States
(12) Patent Application Publication
(10) Pub. No.: US 2025/0094828 A1
(43) Pub. Date: Mar. 20, 2025

(54) KNOWLEDGE GRAPH FOR SEMANTIC SEARCHING OF HANDWRITTEN DOCUMENTS

(71) Applicant: Wacom Co., Ltd., Saitama (JP)

(72) Inventors: Markus WEBER, Düsseldorf (DE); Dilyana BODOVSKA, Sofia (BG); Nikolay VASILEV, Sofia (BG)

(21) Appl. No.: 18/355,948

(22) Filed: Jul. 20, 2023

(51) Int. Cl. G06N 5/022; G06V 30/24

(52) U.S. Cl. CPC G06N 5/022; G06V 30/24

(57) ABSTRACT

A method for building a knowledge graph from handwritten documents is disclosed. The method includes receiving a handwritten document along with dynamic handwritten data from an electronic device and recognizing potential terms for objects in the handwritten document by employing a handwriting recognition technique. The potential terms for each object include a closest recognized term and at least one alternative recognized term. The method also includes determining conceptual terms from the potential recognized terms. Furthermore, the method includes determining a multi-level relation between one or more potential recognized terms and the handwritten document. Thereafter, the method includes building a knowledge graph based on the plurality of potential terms, the one or more conceptual terms, the determined multi-level relation between the one or more potential recognized terms and the handwritten document, or a combination thereof.

### BACKGROUND

### Technical Field

The present disclosure relates to the field of handwritten data, and in particular, relates to a system and method for enabling semantic searching of handwritten documents.

### Description of the Related Art

With the fast-growing adaptation of digital writing pads, such as tablets, electronic boards, pen tablets, or the like, more and more documents are being generated in the form of a handwritten electronic document, herein referred to as handwritten documents. Such handwritten documents are easy to create and store but when it comes to searching for any content in such handwritten documents, the existing search systems fail to return the right set of results, as most of the existing search systems return results based on keyword matches. With advancements in technology, search systems have started providing results based on semantic matches. For enabling better semantic search, some of the existing systems have started organizing the information and data using knowledge graphs instead of traditional tabular data structures or traditional indexing methods.

A knowledge graph is a knowledge base that uses a graph-structured data model or topology to integrate data such as digital documents. Typically, the knowledge base determines a plurality of identifiers corresponding to a plurality of terms in a digital document and associates them with one another based on certain rules to form the topology. Therefore, the knowledge graphs help search systems provide results based on semantics matches. However, such semantic search systems may work with optimum accuracy in case of the digital documents having textual data, but they fail when the documents are handwritten documents because of various reasons.

Some of the reasons why traditional systems fail to return the right results include errors in handwriting recognition of handwritten documents. Such wrong recognitions are especially observed in cases when handwritten data is associated with terms that are not well defined in generally known dictionaries. Such terms may be local terms used within an organization, names, jargons, slangs, abbreviations, or the like. For example, if the handwritten data is associated with ‘Intuos’ which is a type of pen tablet, then the handwriting recognition recognizes it as ‘Intros’ because ‘Intros’ is similar to ‘Intuos’ and is well defined in the generally known dictionaries. Handwriting recognition systems may generate “intuos” as one of the alternative terms, but may conclude to select “intros” because of dictionary match. These alternative terms might be of great importance but get discarded once the handwriting recognition system concludes to select its best matching term. As handwriting recognition may discard “intuos,” the search system will never include any result for the term “intuos.”

Thus, the conventionally known technologies for searching handwritten documents via the knowledge graphs lack accuracy and increase searching time, thereby causing inconvenience to the user. Therefore, there is a need for an improved knowledge graph of handwritten documents, and a semantic searching system for enabling semantic searching of handwritten documents using the knowledge graph to overcome the above-mentioned drawbacks of the known technologies.

### BRIEF SUMMARY

One or more embodiments are directed to a system and method for building a knowledge graph from handwritten documents and enabling searching of handwritten documents using the knowledge graph.

An embodiment of the present disclosure discloses a system for building a knowledge graph from handwritten documents. The system includes a receiver module configured to receive a handwritten document along with dynamic handwritten data from an electronic device. The dynamic handwritten data is received in the form of one or more tuples having data on x-axis, data on y-axis, pressure, speed of writing, orientation, or a combination thereof.

Further, the system includes a recognition module to recognize a plurality of potential terms for one or more objects in the handwritten document by employing a handwriting recognition technique. The plurality of potential terms for each of the one or more objects includes a closest recognized term and at least one alternative recognized term. In an embodiment, the handwriting recognition techniques analyze each of the received one or more tuples to identify the closest recognized term along with one or more alternative recognized terms that each of the received one or more tuples potentially represents.

The system further includes a concept building module to determine one or more conceptual terms from one or more potential recognized terms of the plurality of potential terms. In an embodiment, the concept building module is configured to perform a named entity linking on the plurality of potential terms to determine the corresponding one or more conceptual terms. Further, the one or more conceptual terms include terms corresponding to the recognized text in one or more languages, one or more synonym terms corresponding to the recognized text, one or more abbreviation terms corresponding to the recognized text, one or more internally defined terms corresponding to the recognized text, or a combination thereof. Further, the concept building module is configured to determine a multi-level relation between one or more potential recognized terms and the handwritten document.

The system also includes a knowledge graph building module to build a knowledge graph based on the plurality of potential terms, the one or more conceptual terms, the determined multi-level relation between the one or more potential recognized terms and the handwritten document, or a combination thereof. In an embodiment, the knowledge graph is used to enable at least a semantic searching of one or more handwritten documents. In order to build the knowledge graph, each of the plurality of potential terms along with the one or more corresponding conceptual terms are placed as a node in the built knowledge graph. Further, one node is connected to another node based on the determined multi-level relation between the corresponding potential recognized terms and the handwritten document.

In an embodiment, the knowledge graph building module is further configured to facilitate the user to set visibility of newly added nodes and their relationships in the knowledge graph. In another embodiment, the knowledge graph building module is further configured to automatically set visibility of newly added nodes and their relationships in the knowledge graph based on historical visibilities of nodes and their relationships. Accordingly, based on the set visibility, the one or more nodes and their relationships are divided into one or more public nodes and relationships corresponding to the documents publicly available to each user, one or more shared nodes and relationships corresponding to the documents on a subject to which the user is invited, and one or more private nodes and relationships corresponding to the documents that are specific to one user.

An embodiment of the present disclosure discloses a method for building a knowledge graph from handwritten documents. The method includes receiving a handwritten document along with dynamic handwritten data from an electronic device. Next, the method includes recognizing a plurality of potential terms for one or more objects in the handwritten document by employing a handwriting recognition technique. The plurality of potential terms for each of the one or more objects includes a closest recognized term and at least one alternative recognized term. In an embodiment, the handwriting recognition techniques analyze each of the received one or more tuples to identify the closest recognized term along with one or more alternative recognized terms that each of the received one or more tuples potentially represents.

Upon recognizing a plurality of potential terms, the method includes determining one or more conceptual terms from one or more potential recognized terms of the plurality of potential terms. In order to determine the one or more conceptual terms, the method is configured to perform a named entity linking on the plurality of potential terms to determine the corresponding one or more conceptual terms. Next, the method includes determining a multi-level relation between one or more potential recognized terms and the handwritten document.

Thereafter, the method includes building a knowledge graph based on the plurality of potential terms, the one or more conceptual terms, the determined multi-level relation between the one or more potential recognized terms and the handwritten document, or a combination thereof. In an embodiment, the knowledge graph is used to enable at least a semantic searching of the one or more handwritten documents.

An embodiment of the present disclosure discloses a semantic searching system for searching handwritten documents using a knowledge graph. The semantic searching system includes a receiver module configured to receive, from an electronic device, text data having one or more terms associated with a user's intended search. Further, the semantic searching system includes an entity recognition module configured to perform entity recognition from the text data to determine one or more entities present in the text data. The semantic searching system also includes a concept determination module configured to determine one or more conceptual terms for each of the determined one or more entities via a named entity linking. Furthermore, the semantic searching system includes an activation graph creation module configured to create an activation graph based on the determined one or more conceptual terms by adding nodes and their relationships corresponding to terms corresponding to the recognized entity in one or more languages, one or more synonym terms corresponding to the recognized entity, one or more abbreviation terms corresponding to the recognized entity, one or more internally defined terms corresponding to the recognized entity, or a combination thereof.

The semantic searching system also includes an associative searching module to perform an associated searching for obtaining the one or more search results based on matching of the one or more nodes of the activation graph with one or more nodes of the knowledge graph. Further, the semantic searching system includes a direct searching module that is configured to pre-process the received text data by performing at least one of: tokenization, removal of stop words, removal of punctuation marks, and removal of spaces. Upon pre-processing, the direct searching module is configured to perform a direct searching by matching the pre-processed received text data with one or more nodes of the comprehensive knowledge graph for obtaining the one or more search results.

In an embodiment, the associative searching module and the direct searching module select the search results based on an accessibility level of the user and visibility level of the one or more nodes and their relationships. Further, the visibility level of the one or more nodes and their relationships are either automatically defined based on historical visibilities of nodes and their relationships or manually defined based on user inputs in a documents database. In an embodiment, based on the pre-defined visibility, the documents database includes one or more public documents corresponding to the documents publicly available to each user, one or more shared documents corresponding to the documents on a subject to which the user is invited, or one or more private documents corresponding to the documents that are specific to one user.

Additionally, the semantic searching system includes a rendering module to render ranked and selected search results to the user, wherein the one or more ranked and selected search results include shortcuts to open a handwritten document associated with the search results and online links associated with the search results.

The features and advantages of the subject matter here will become more apparent in light of the following detailed description of selected embodiments, as illustrated in the accompanying FIGURES. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE SEVERAL VIEWS OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates a block diagram of a system for managing handwritten documents, in accordance with various embodiments of the present disclosure.

FIG. 2 illustrates a block diagram of a knowledge graph building system for building a knowledge graph of handwritten documents, in accordance with various embodiments of the present disclosure.

FIG. 3A illustrates an example of handwriting recognition of potential terms, in accordance with an embodiment of the present disclosure.

FIG. 3B illustrates an example of a closest recognized term and one or more alternative recognized terms for a handwritten text, in accordance with an embodiment of the present disclosure.

FIG. 4 illustrates an example of a digital note formed from a handwritten document, in accordance with an embodiment of the present disclosure.

FIG. 5 illustrates exemplary function for generating conceptual terms from the recognized terms, in accordance with an embodiment of the present disclosure.

FIG. 6 illustrates an example multi-level relation between two potential recognized terms, in accordance with an embodiment of the present disclosure.

FIG. 7 illustrates an example knowledge graph built from a note, in accordance with an embodiment of the present disclosure.

FIG. 8A illustrates a block diagram of a semantic searching system for searching handwritten documents using a knowledge graph, in accordance with an embodiment of the present disclosure.

FIG. 8B illustrates an associative searching module, in accordance with an embodiment of the present disclosure.

FIG. 9 illustrates one or more documents stored in different data spaces in a document database, in accordance with an embodiment of the present disclosure.

FIG. 10 illustrates an example implementation of the semantic searching system that provides cross-language results, in accordance with an embodiment of the present disclosure.

FIG. 11 illustrates another implementation of the semantic searching system that provides results based on private knowledge, in accordance with another embodiment of the present disclosure.

FIG. 12A illustrates a portion of the knowledge graph created via a traditional system.

FIG. 12B illustrates a portion of the knowledge graph created via the knowledge graph building system, in accordance with an embodiment of the present disclosure.

FIG. 13 illustrates a flowchart of a method for building a knowledge graph from handwritten documents, in accordance with an embodiment of the present disclosure.

FIG. 14 illustrates a flowchart of a method for searching handwritten documents using a knowledge graph, in accordance with an embodiment of the present disclosure.

FIG. 15 illustrates an exemplary computer system in which or with which embodiment of the present disclosure may be utilized.

Other features of embodiments of the present disclosure will be apparent from the accompanying drawings and the detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled,” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may,” “can,” “could,” or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the FIGURES may be provided through the use of dedicated hardware as well as hardware capable of executing associated software. Similarly, any switches shown in the FIGURES are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and thus, are not intended to be limited to any particular named.

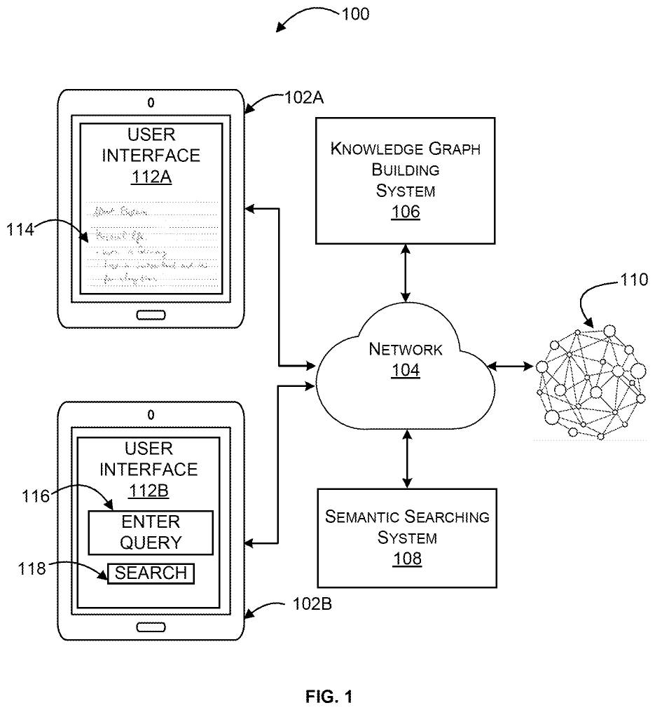

FIG. 1 illustrates a block diagram of a system 100 for managing handwritten documents, in accordance with various embodiments of the present disclosure. A handwritten document, for the purpose of the disclosure, corresponds to a digital document having handwritten data. Such handwritten data may correspond to one or more words on the digital document, a sentence on the digital document, or the entire digital document in general. Further, the handwritten data may include static handwritten data and dynamic handwritten data. The static handwritten data may correspond to the geometrical data associated with the user's handwritten data, such as in the form of an image. The dynamic handwritten data may correspond to a chronological sampling of movement of handwritten data, such as data on x-axis, data on y-axis, pressure, speed of writing, and orientation. The managing of the handwritten documents, for the purpose of the disclosure, corresponds to building a knowledge graph including the handwritten documents as nodes, such that the handwritten documents can be searched easily and efficiently.

In one embodiment of the present disclosure, as shown in FIG. 1, the system 100 for managing handwritten documents may be implemented on a server and may include one or more user devices 102A, 102B, a network 104, a knowledge graph building system 106, semantic searching system 108, and a knowledge graph 110.

In an illustrated embodiment, to prepare a handwritten document 114, a user may access a user interface 112A on the user device 102A to write data to be added to the handwritten document 114. The written data, hereinafter termed as handwritten data, may include one or more words, one or more sentences, one or more paragraphs, shapes, and formulas. The user device 102A may correspond to a touch-enabled device, a stylus enabled device, or a pen-enabled device configured to permit a user to input the handwritten data in association with preparing the handwritten document via touch, stylus, and pen, respectively. Accordingly, the user device may, without any limitation, include a mobile phone, a tablet, a personal computer, a digital signage, a smartboard, and a television. The user may provide, via the network 104, the prepared handwritten document 114 to the knowledge graph building system 106 for building the knowledge graph 110. Alternatively, or additionally, the prepared handwritten document 114 may be added as a new node for updating an existing knowledge graph. Such built or updated knowledge graphs may be saved on a storage, such as a cloud storage. The knowledge graph building system 106 will be described in detail below.

In another illustrated embodiment, to search for the handwritten document 114 that is saved on the storage, the user may access a user interface 112B of the user device 102B. The user interface 112B may have an “ENTER QUERY” option 116 where the user may be allowed to type in one or more search words and initiate a search by selecting a “SEARCH” option 118 to search for the handwritten document 114. In an embodiment, the search option 118 may allow the user to write a query and enable searching through the handwritten query. Such types of one or more search words are then provided to the semantic searching system 108 via the network 104. The semantic searching system 108 may be configured to determine entities and conceptual terms associated with the one or more search words to build an activation graph. Further, the semantic searching system 108 matches the built activation graph with the knowledge graph 110 stored in the storage to obtain one or more search results, such as shortcuts to open the associated handwritten documents or online links associated with the search results. The semantic searching system 108 will be described in detail below.

In another embodiment of the present disclosure, the system 100 may be implemented on the electronic device locally, such that the handwritten document may be received from the user interface and the knowledge graph building and the semantic searching may be performed by one or more modules in the electronic device. The electronic device may correspond to a touch-enabled device, a stylus enabled device, or a pen-enabled device configured to permit a user to input the signature data in association with the user signing his or her name on a screen via touch, stylus, or pen, respectively. Accordingly, the electronic device may, without any limitation, include a mobile phone, a tablet, a personal computer, a digital signage, a smartboard, and a television.

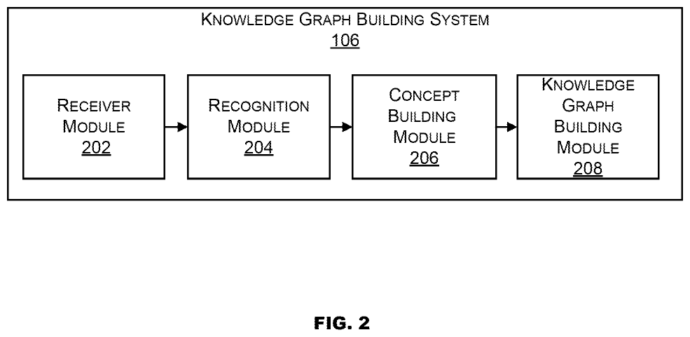

FIG. 2 illustrates a block diagram of a knowledge graph building system 106 for building a knowledge graph of handwritten documents, in accordance with various embodiments of the present disclosure. The knowledge graph building system 106 may include a receiver module 202, a recognition module 204, a concept building module 206, and a knowledge graph building module 208. The receiver module 202, the recognition module 204, the concept building module 206, and the knowledge graph building module 208 may be communicatively coupled to a memory and a processor of the knowledge graph building system 106.

The processor may be configured to control the operations of the receiver module 202, the recognition module 204, the concept building module 206, and the knowledge graph building module 208. In an embodiment of the present disclosure, the processor and the memory may form a part of a chipset installed in the knowledge graph building system 106. In another embodiment of the present disclosure, the memory may be implemented as a static memory or a dynamic memory. In an example, the memory may be internal to the knowledge graph building system 106, such as an onsite-based storage. In another example, the memory may be external to the knowledge graph building system 106, such as cloud-based storage. Further, the processor may be implemented as one or more microprocessors, microcomputers, digital signal processors, central processing units, state machines, logic circuitries, and/or any devices that manipulate signals based on operational instructions.

In an embodiment of the present disclosure, the receiver module 202 may receive a handwritten document along with dynamic handwritten data from an electronic device. The dynamic handwritten data may be received in the form of tuples such as (x, y, p, s, o), wherein the ‘x’ may be data on x-axis, ‘y’ may be data on y-axis, ‘p’ may be pressure, ‘s’ may be speed of writing, and ‘o’ may be orientation.

In an embodiment of the present disclosure, the recognition module 204 may recognize a plurality of potential terms for each of one or more objects in the handwritten document. The one or more objects may include words, symbols, equations, shapes, or the like that can be drawn or handwritten by the user and has a meaning or significant importance. Further, the plurality of potential terms may be recognized by employing a handwriting recognition technique (e.g., universal ink model). To recognize the plurality of potential terms, the handwritten recognition technique may be configured to analyze each of the received one or more tuples to identify a closest recognized term along with one or more alternative recognized terms for each of the one or more objects. Thus, the plurality of potential terms includes the closest recognized term and one or more alternative recognized terms that each of the one or more tuples potentially represents.

In an embodiment of the present disclosure, the concept building module 206 may be configured to determine one or more conceptual terms from one or more potential recognized terms of the plurality of potential terms. The concept building module 206 may be configured to perform a named entity linking on the plurality of potential terms to determine the corresponding one or more conceptual terms. Further, the one or more conceptual terms may include, without any limitation, terms corresponding to the recognized text in one or more languages, one or more synonym terms corresponding to the recognized text, one or more abbreviation terms corresponding to the recognized text, one or more internally defined terms corresponding to the recognized text, or a combination thereof. Further, the concept building module 206 may determine a multi-level relation between one or more potential recognized terms and the handwritten document.

In an embodiment of the present disclosure, the knowledge graph building module 208 may build a knowledge graph 110. The knowledge graph building module 208 may build the knowledge graph 110 based on the plurality of potential terms, the one or more conceptual terms, the determined multi-level relation between the one or more potential recognized terms and the handwritten document, or a combination thereof. To build the knowledge graph 110, the knowledge graph building module 208 may place each of the plurality of potential terms along with the one or more corresponding conceptual terms as a node in the knowledge graph. Further, the knowledge graph building module 208 may connect one node to another based on the determined multi-level relation between the corresponding potential recognized terms and the handwritten document.

In one embodiment of the present disclosure, the knowledge graph building module 208 may facilitate the user to set visibility of newly added nodes and their relationships in the knowledge graph 110. In another embodiment of the present disclosure, the knowledge graph building module 208 may automatically set the visibility of the newly added nodes and their relationships in the knowledge graph 110 based on the historical visibility of similar nodes and their relationships. Based on the set visibility, either manually or automatically, the knowledge graph building module 208 may be configured to divide the one or more nodes and their relationships into public, shared, and private. The one or more public nodes and relations correspond to the documents that are publicly available to each user. Depending on the public, shared, or private tag associated with the notes or their relationship, such portion of the knowledge graphs can be stored in public space, shared space, or private space. The one or more shared nodes and relationships correspond to the documents on a subject, to which the user is invited. The one or more private nodes and relationships correspond to the documents that are specific to one user. Such knowledge graphs 110 may be utilized to enable a semantic searching of the one or more handwritten documents, as will be described in detail below.

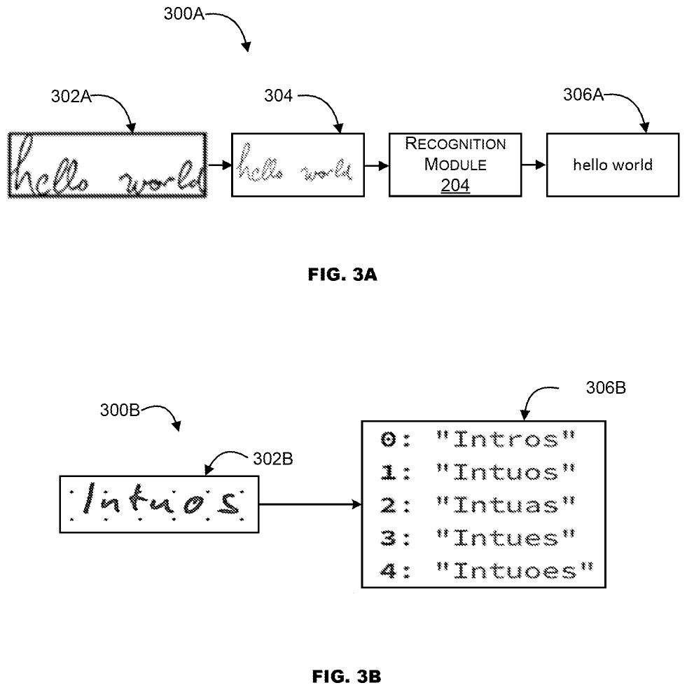

FIG. 3A illustrates an example 300A of handwriting recognition of potential terms, in accordance with an embodiment of the present disclosure. FIG. 3B illustrates an example 300B of a closest recognized term and one or more alternative recognized terms for a handwritten text, in accordance with an embodiment of the present disclosure. For the sake of brevity, FIGS. 3A and 3B will be explained together. In an illustrated embodiment, the recognition module 204 may get a handwritten document 302A having a handwritten text as an object 304. As shown, the handwritten text indicates ‘hello world.’ The recognition module 204 may process the handwritten document 302A to extract the object 304 from the handwritten document 302A. Further, the recognition module 204 may use an ink to text model to recognize the potential term 306A, i.e., ‘hello world.’

In an embodiment of the present disclosure, as shown in FIG. 3B, the recognition module 204 may receive a handwritten document 302B having a handwritten text ‘intuos’ as an object. The recognition module 204 may be configured to detect the object and apply the ink-to-text model to output the one or more potential objects, as shown in 306B. The recognition module 204 may be configured to output the closest recognized term ‘intros.’ as shown in 306B, based on one or more conditions, such as higher rank in the English dictionary, frequent use in the past, and user preferences. Along with the closest recognized term, the recognition module 204 may also have identified one or more alternative recognized terms, i.e., ‘intuos,’ ‘intuas,’ ‘intues,’ and ‘intuoes,’ as shown in 306B that may be ranked lower than the closest recognized terms but may also be an interpretation of the object in the handwritten document 302B. Once the selection of a recognized term is done, the traditional systems discard the alternative terms that they may have identified. On the other hand, the present disclosure uses these alternate terms instead of discarding these to enhance the knowledge graph 110 and provide better semantics search results. How these alternate terms are used is discussed in detail below.

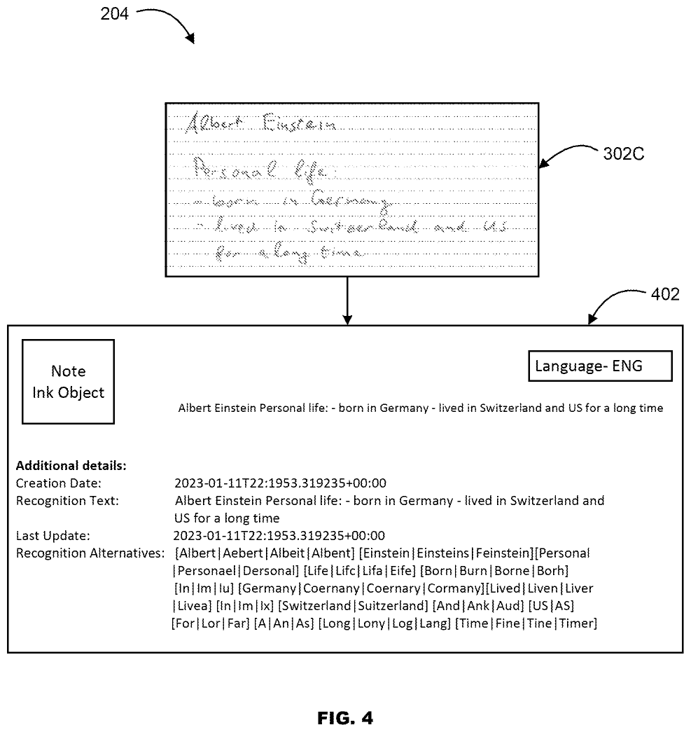

FIG. 4 illustrates an example of a digital note 402 formed from a handwritten document 302C, in accordance with an embodiment of the present disclosure. In an embodiment of the present disclosure, the recognition module 204 may receive the handwritten document 302C having a plurality of objects associated with handwritten text. The recognition module 204 may be configured to recognize a plurality of potential terms based on the plurality of objects. Further, the recognition module 204 may output the result in the form of the digital note 402. The digital note 402 may include a recognition of the handwritten text based on the closest recognized terms, along with date stamps such as creation date and last update date. The digital note 402 may also include one or more alternative recognized terms under ‘recognition alternatives’. Additionally, the digital note 402 may also indicate that the handwritten document 302C is in English language and the type of associated objects includes ink objects.

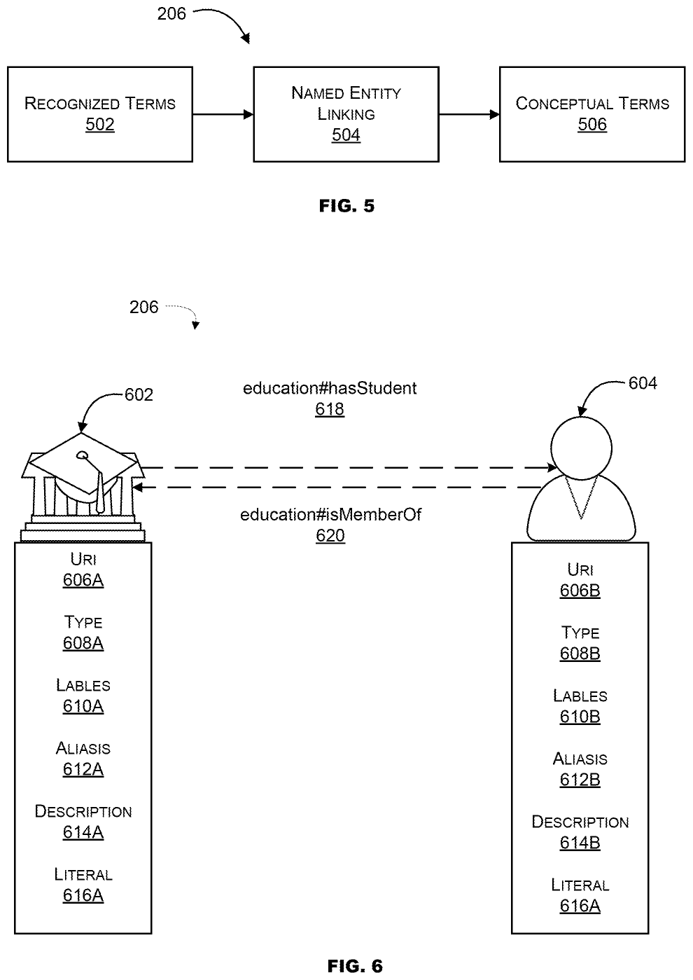

FIG. 5 illustrates exemplary function for generating conceptual terms 506 from recognized terms 502, in accordance with an embodiment of the present disclosure. The concept building module 206 may be configured to utilize the named entity linking 504 to determine one or more conceptual terms from the one or more recognized terms 502. For example, if the recognized term 502 is ‘knowledge graph’ then the concept building module 206 may determine one or more conceptual terms 506 including synonym terms such as ‘semantic network,’ an abbreviation term such as ‘KG,’ and a term in different language such as ‘Wissengraph’ in German.

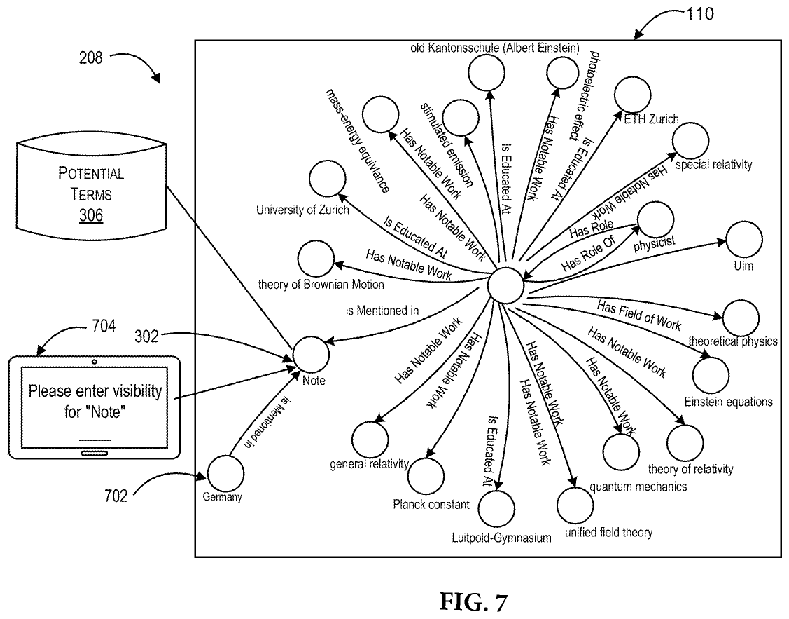

FIG. 6 illustrates an example multi-level relation between two potential recognized terms, in accordance with an embodiment of the present disclosure. In an embodiment of the present disclosure, the concept building module 206 is configured to determine two potential recognized terms ‘Playdium’ and ‘Harry’ associated with a school icon 602 and a personal picture 604, respectively. The school icon 602 has a corresponding Unique identifier (URI) 606A such as 2y5sch001, a type 608A such as education #school, a label 610A such as Playdium school of witchcraft and wizadry@en_US, an aliases 612A such as Playdium@en_US, a description 614A such as Playdium is a fictional Scottish boarding school of magic@en_US, and literal 616A such as 10^{th} century. Further, the personal picture 604 has a corresponding URI 606B such as 5b5stu008, a type 608B such as core #person, a label 610B such as Harry@en_US, an aliases 612B such as HS, a description 614B such as Harry is a fictional character@en_US, and literal 616B such as Harry@en_US and Simons@en_US. In an embodiment, the icon may be a visual representation of the potential term, the type may be defined within an ontology used by the knowledge graph 110, the label may be considered as the main label while others may be considered as the aliases, the description may be a short multilingual description of the potential term, and the literals are properties of the potential term which are defined in the ontology for providing additional information of the potential terms. The concept building module 206 may be configured to determine a multi-level relation between the two potential terms based on the abovementioned corresponding data. For example, the concept building module 206 may determine a first relation 618 in which Playdium (school) 602 has a student named Harry 604, and a second relation 620 in which Harry 604 is a member (student) of Playdium 602.

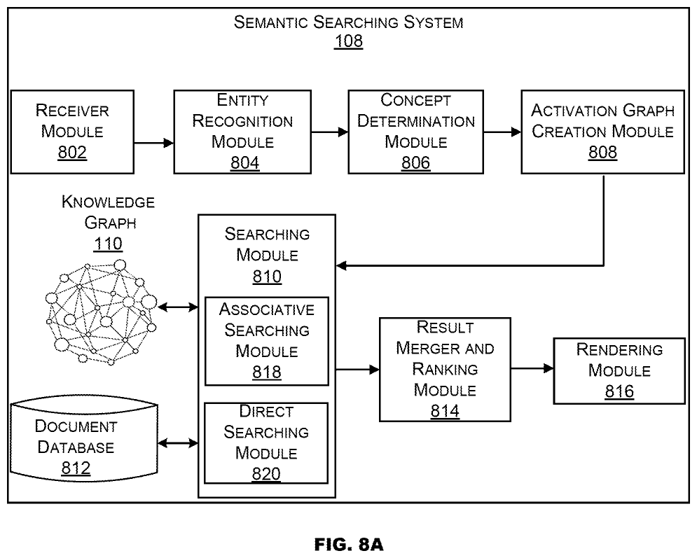

FIG. 7 illustrates an example knowledge graph built from a note, in accordance with an embodiment of the present disclosure. In an embodiment of the present disclosure, the knowledge graph building module 208 may be configured to build the knowledge graph 110 by adding a node containing the handwritten document 302 based on the potential recognized terms 306. The knowledge graph building module 208 may also add a node 702 of a corresponding concept such as the German language to represent the fact that the handwritten document 302 is in German language. Additionally, the knowledge graph building module 208 may be configured to facilitate a user to set the visibility of the newly added node of the handwritten document. To set such visibility, an option to set visibility may be displayed on the user device, as shown in 704.

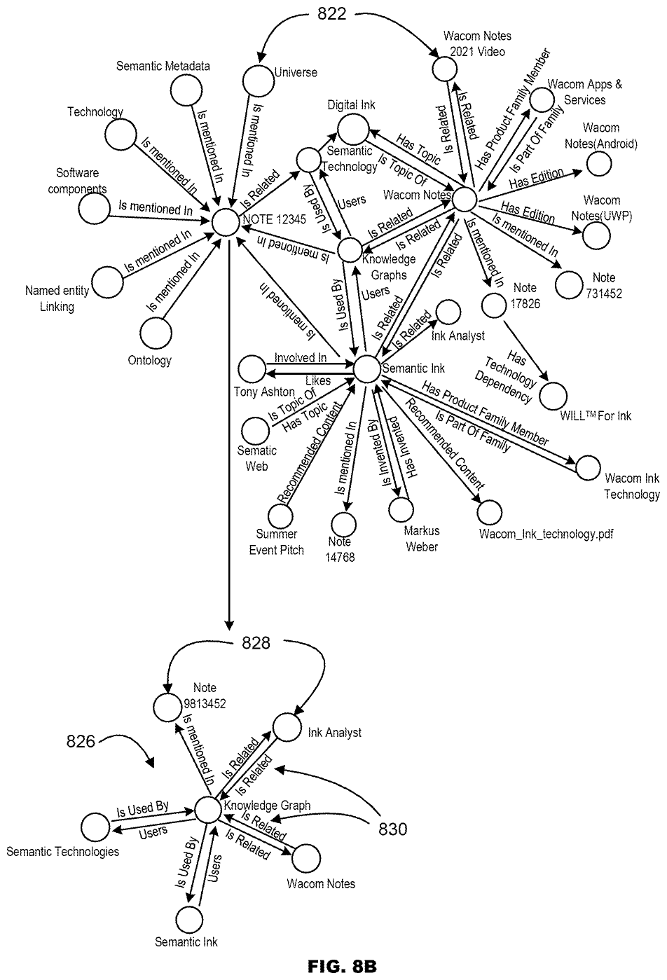

FIG. 8A illustrates a block diagram of a semantic searching system 108 for searching handwritten documents using a knowledge graph, in accordance with an embodiment of the present disclosure. FIG. 8B illustrates an associative searching module 818, in accordance with an embodiment of the present disclosure. For the sake of brevity, FIGS. 8A and 8B will be explained together. In an embodiment of the present disclosure, the semantic searching system 108 may include a receiver module 802, an entity recognition module 804, a concept determination module 806, an activation graph creation module 808, a searching module 810, the knowledge graph 110, a document database 812, a result merger and ranking module 814, and a rendering module 816. The receiver module 802, the entity recognition module 804, the concept determination module 806, the activation graph creation module 808, the searching module 810, the knowledge graph 110, the document database 812, the result merger and ranking module 814, and the rendering module 816 may be communicatively coupled to at least a memory and a processor of the semantic searching system 108.

The processor may be configured to control the operations of receiver module 802, the entity recognition module 804, the concept determination module 806, the activation graph creation module 808, the searching module 810, the knowledge graph 110, the document database 812, the result merger and ranking module 814, and the rendering module 816. In an embodiment of the present disclosure, the processor and the memory may form a part of a chipset installed in the semantic searching system 108. In another embodiment of the present disclosure, the memory may be implemented as a static memory or a dynamic memory. In an example, the memory may be internal to the semantic searching system 108, such as an onsite-based storage. In another example, the memory may be external to the semantic searching system 108, such as cloud-based storage. Further, the processor may be implemented as one or more microprocessors, microcomputers, digital signal processors, central processing units, state machines, logic circuitries, and/or any devices that manipulate signals based on operational instructions.

In an embodiment of the present disclosure, the receiver module 802 may be configured to receive a text data having one or more terms associated with a user's intended search. The text data may be received from an electronic device in the form of handwritten text and may be typed by the user in a search window of the electronic device. The entity recognition module 804 performs entity recognition from the text data to determine one or more entities present in the text data. Thereafter, the concept determination module 806 determines one or more conceptual terms for each of the determined one or more entities via a named entity linking.

In an embodiment of the present disclosure, the activation graph creation module 808 creates an activation graph 826 based on the determined one or more conceptual terms by adding nodes 828 and their relationships 830 to identify nodes that are two or more hops away. The relationships 830 may correspond to terms corresponding to the recognized entity in one or more languages, one or more synonym terms corresponding to the recognized entity, one or more abbreviation terms corresponding to the recognized entity, one or more internally defined terms corresponding to the recognized entity, or a combination thereof.

In an embodiment of the present disclosure, the searching module 810 may be configured to find one or more search results to be rendered to the user. The searching module 810 may include an associative searching module 818 and a direct searching module 820. The associative searching module 818 performs an associated searching to obtain the one or more search results. The associated searching is based on matching of the one or more nodes 828 of the activation graph with one or more nodes 822 of the knowledge graph 100. In order to perform the associated searching, the associative searching module 818 performs a first-level depth search by checking for all the relations of the recognized entity in the knowledge graph 110 to find the matching entities. Further, the associative searching module 818 may be configured to perform a second-level depth search by checking for the relations of the matched entities in the knowledge graph 110 to find the entities associated with the matched entities. In an embodiment of the present disclosure, the associative searching module 818 may select the search results based on the accessibility level of the user and the visibility level of the one or more nodes and their relationships. In an embodiment, such visibility level of the one or more nodes and their relationships may be automatically defined based on the historical visibilities of similar nodes and their relationships. In another embodiment, such visibility level of the one or more nodes and their relationships may be manually defined based on the historical visibilities of nodes and their relationships.

The direct searching module 820 may be configured to pre-process the received text by performing tokenization, removal of stop words, removal of punctuation marks, removal of spaces, or a combination thereof. Upon pre-processing, the direct searching module 820 may be configured to perform a direct searching by matching the pre-processed received text data with one or more nodes of the comprehensive knowledge graph for obtaining the one or more search results.

The documents to be searched include handwritten documents. In an embodiment of the present disclosure, the document database 812 may include one or more documents divided based on the pre-defined visibility. The documents database 812 may include, without any limitation, one or more public documents corresponding to the documents publicly available to each user, one or more shared documents corresponding to the documents on a subject to which the user is invited, and one or more private documents corresponding to the documents that are specific to one user.

In an embodiment of the present disclosure, the result merger and the ranking module 814 may be configured to merge the one or more search results from the associative searching module 818 and the direct searching module 820. Upon merging, the result merger and the ranking module 814 may be configured to rank the merged one or more search results.

In an embodiment of the present disclosure, the rendering module 816 renders ranked and selected search results to the user. The one or more ranked and selected search results may include, without any limitation, shortcuts to open a handwritten document associated with the search results and online links associated with the search results. The search results may include a source system of the handwritten document and/or a unique ID of the handwritten document, such that the handwritten document may be pulled from the documents database 812 swiftly.

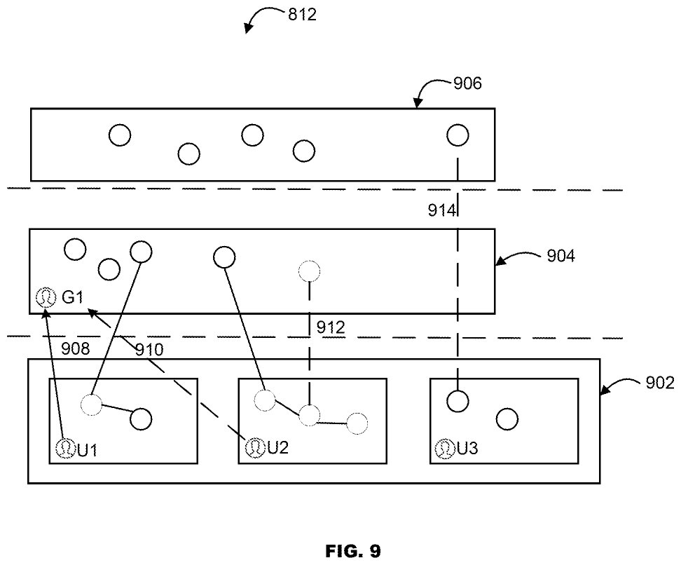

FIG. 9 illustrates one or more documents stored in different data spaces in a document database 812, in accordance with an embodiment of the present disclosure. In an embodiment of the present disclosure, the document database 812 may include a personal space 902, a group space 904, and a tenant space 906 to define the visibilities of one or more entities such as handwritten documents. The tenant space 906 may include entities that can be made accessible for the whole tenant. The group space 904 may be created by a user 908 that may further share the join key for the group with the other users to join a group 910 or may directly add a user to the group 912. The personal space 902 may be assigned to a tenant and its entities may be created in a personal graph that may only be accessible by that user, as shown by 914.

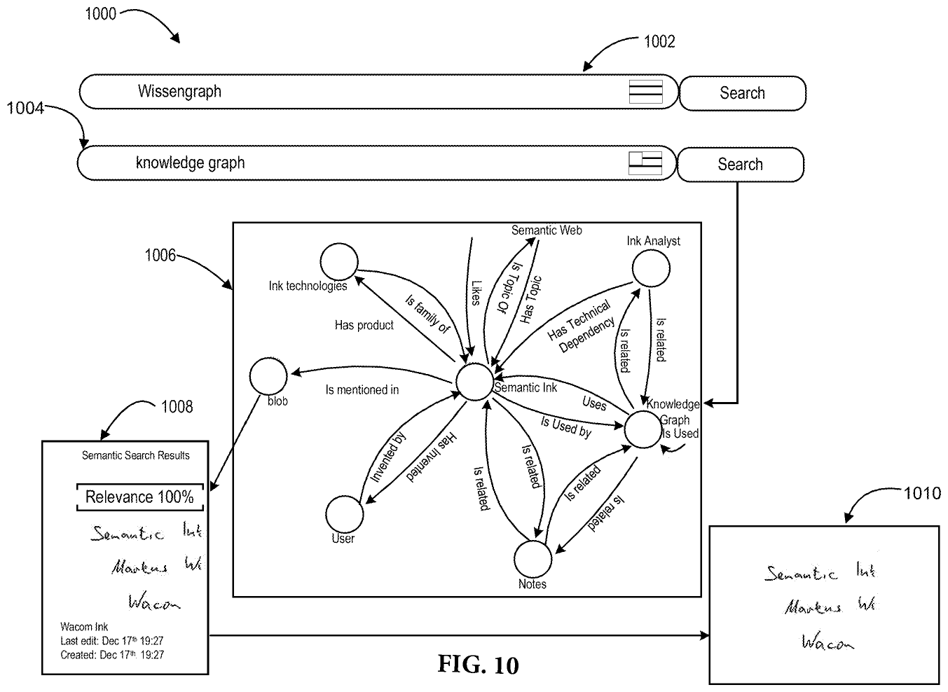

FIG. 10 illustrates an example implementation 1000 of the semantic searching system 108 that provides cross-language results, in accordance with an embodiment of the present disclosure. The semantic searching system 108 may facilitate the user to perform a multi-lingual search by inputting one or more search terms in any language. For example, the user may type ‘Wissengraph’ in German 1002 or ‘Knowledge graph’ in English 1004. The semantic searching system 108 may be configured to find one or more conceptual terms, such as corresponding terms in different languages, for the inputted one or more search terms. Further, the semantic searching system 108 may be configured to form an activation graph of the inputted one or more search terms based on the found one or more conceptual terms. Since, the activation group terms are in various languages, whether the search term is in English or German, it will hold the same significance for the semantic searching system 108. Thereafter, the semantic searching system 108 may be configured to match the nodes of the activation graph with the nodes of the knowledge graph to determine one or more search results 1006. Further, the semantic searching system 108 may be configured to determine a shortcut to the handwritten document associated with the search result to render the search result along with the handwritten document and its shortcut to the user, as shown by 1008.

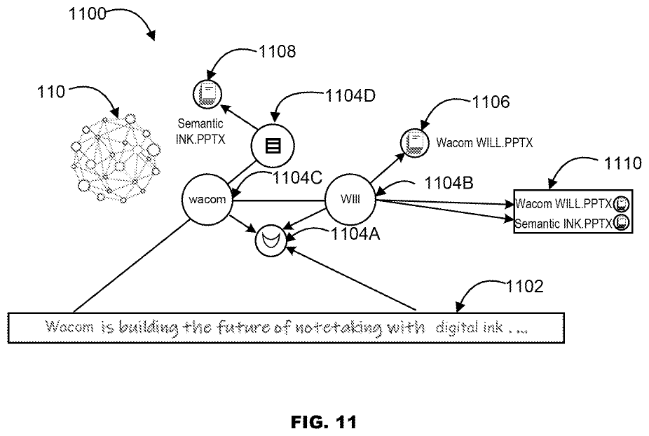

FIG. 11 illustrates another implementation 1100 of the semantic searching system 108 that provides results based on private knowledge, in accordance with another embodiment of the present disclosure. In an embodiment of the present disclosure, the user may input a searching phrase ‘what new product Wacom is developing?’ via one of natural language in the notes, via writing, or via a speech signal. The semantic searching system 108 may identify ‘wacom’ and ‘digital Ink’ as keywords for searching using a named entity linking. Then, the semantic searching system 108 may perform a first-level searching for ‘wacom’ and ‘digital ink’ in the knowledge graph 110, to identify first-level searching nodes 1104C and 1104A respectively marked as private and created from a private note. Thereafter, the semantic searching system 108 may be configured to perform a multi-level searching through notes 1104D and 1104B to find relevant handwritten documents 1108 and 1106, respectively, even from documents or nodes marked as private. Thereafter, the one or more found handwritten documents are rendered to the user as search results, as shown by 1110 if the user has permission to access such nodes and documents. The semantic searching system 108 may provide results based on nodes stored in the private data space. The result may include a private document 1102 mentioning “Wacom is building the future of notetaking with digital ink”. Visibility of the notes and relationships created from the document marked as private will also be marked as private. Such notes and their relationship in knowledge graphs cannot be used to process a search query by another user.

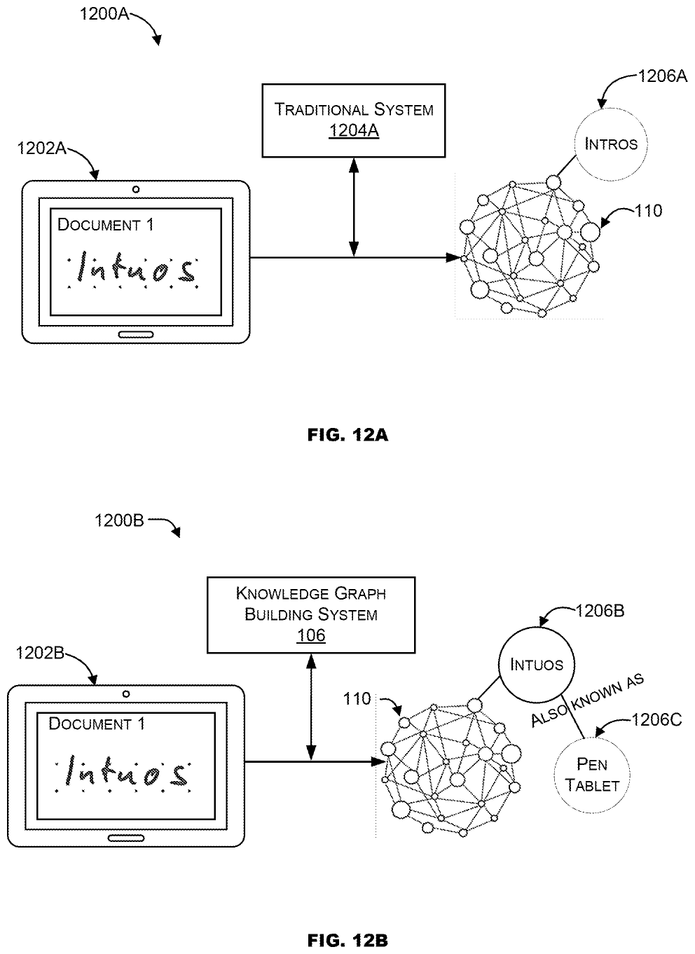

FIG. 12A illustrates the building of the knowledge graph via a traditional system. In the traditional knowledge graph building system 1204A, the user may write a less-known word ‘Intuos’ in a document 1, as shown by 1202A. The document 1 may be sent to the traditional knowledge graph building system 1204A which may be configured to recognize the handwritten word ‘Intuos’ and identifies ‘intros’ as the closest recognized word since it is better known in generally known English dictionaries. The traditional knowledge graph building system 1204A may be configured to add a node 1206A as ‘Intros’ in the knowledge graph 110 representing the document 1, such that if a user searches for ‘intros’ then the document 1 may be presented to the user. Therefore, the traditional knowledge graph building system 1204A lacks accuracy and is prone to give wrong results during searching.

FIG. 12B illustrates building of the knowledge graph via the knowledge graph building system 106, in accordance with an embodiment of the present disclosure. In an embodiment of the present disclosure, the user may write a less-known word ‘Intuos’ in a document 1, as shown by 1202B. Further, the document 1 may be sent to the knowledge graph building system 106, as disclosed in the present disclosure, which may be configured to recognize the handwritten word ‘Intuos’ and identifies ‘intros’ as the closest recognized word along with ‘intuos’ as an alternative recognized word. The knowledge graph building system 106 may be configured to determine one or more conceptual terms for the identified terms along with the relation between the two, such as that ‘Intuos’ is also known as ‘pen tablet’. Accordingly, the knowledge graph building system 106 adds a node 1206B as ‘Intuos’ in the knowledge graph 110 representing the document 1 along with a further node 1206C connected to the node 1206B and defining the relation between the two, such that if a user searches for ‘intuous’ or ‘pen tablet’ then the document 1 may be presented to the user. Therefore, the knowledge graph building system 106, as disclosed in the present disclosure, improves the accuracy of finding handwritten documents during searching.

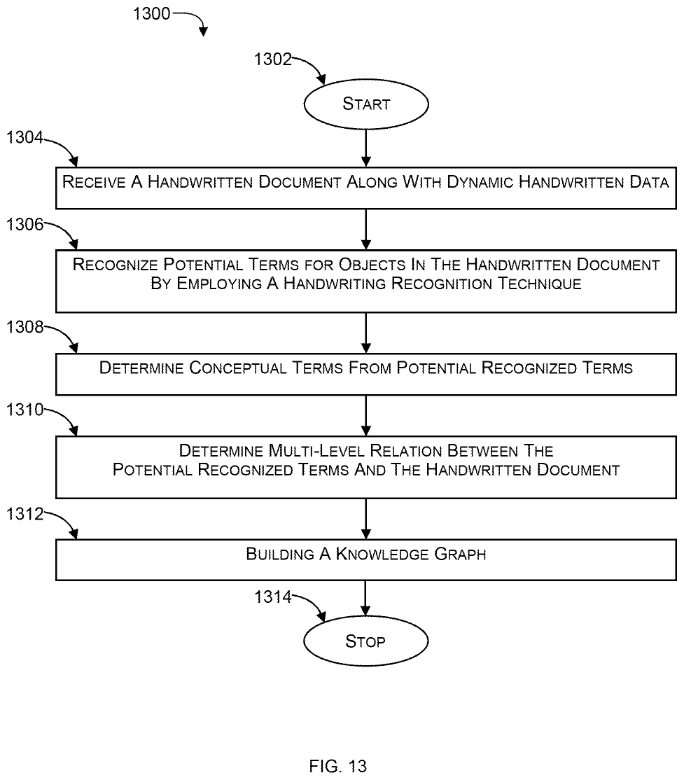

FIG. 13 illustrates a flowchart 1300 of a method for building a knowledge graph of handwritten documents, in accordance with an embodiment of the present disclosure. The method starts at step 1302.

At first, the handwritten document may be received, at step 1304 from an electronic device. The handwritten document may be received along with dynamic handwritten data. Next, at step 1306, a plurality of potential terms for one or more objects in the handwritten document may be recognized. The plurality of potential terms may be recognized by employing a handwritten recognition technique. Further, the handwriting recognition techniques analyze each of the received one or more tuples to identify the closest recognized term along with one or more alternative recognized terms that each of the received one or more tuples potentially represents. Accordingly, the plurality of terms for each of the one or more objects may include a closest recognized term and one or more alternative recognized terms.

Then, one or more conceptual terms may be determined, at step 1308, from the one or more potential recognized terms of the plurality of potential terms. The one or more conceptual terms may be determined by performing a named entity linking on the plurality of potential terms. After that, a multi-level relation between the one or more potential recognized terms and the handwritten document may be determined, at step 1310.

Thereafter, a knowledge graph may be built, at step 1312, based on the plurality of potential terms, the one or more conceptual terms, the determined multi-level relation between the one or more potential recognized terms and the handwritten document, or a combination thereof. In order to build the knowledge graph, each of the plurality of potential terms along with the one or more corresponding conceptual terms are placed as a node in the built knowledge graph. Further, one node is connected to another node based on the determined multi-level relation between the corresponding potential recognized terms and the handwritten document. The knowledge graph may be used to enable a semantic searching of the one or more handwritten documents.

In an embodiment of the present disclosure, the method includes facilitating the user to set visibility of the one or more newly added nodes and their relationships in the knowledge graph. In another embodiment of the present disclosure, the method further includes automatically setting visibility of the one or more newly added nodes and their relationships in the knowledge graph based on historical visibilities of nodes and their relationships. The method ends at step 1314.

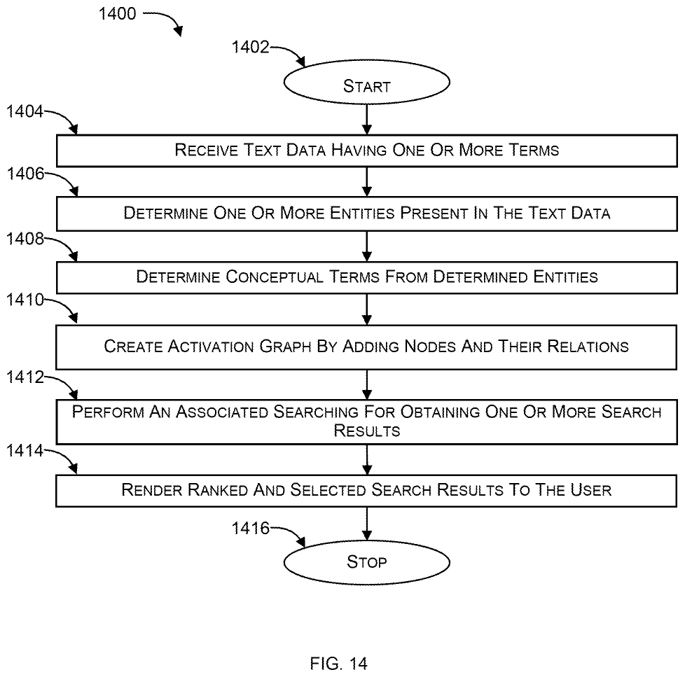

FIG. 14 illustrates a flowchart 1400 of a method for searching handwritten documents using a knowledge graph, in accordance with an embodiment of the present disclosure. The method starts at step 1402.

At first, text data having one or more terms associated with user's intended search are received, at step 1404 from an electronic device. Further, one or more entities present in the text data are determined, at step 1406, by performing entity recognition.

Further, one or more conceptual terms are determined, at step 1408, for each of the determined one or more entities. The one or more conceptual terms are determined via a named entity linking. After that, an activation graph may be created, at step 1410, by adding nodes and their relationships corresponding to terms corresponding to the recognized entity in one or more languages, one or more synonym terms corresponding to the recognized entity, one or more abbreviation terms corresponding to the recognized entity, one or more internally defined terms corresponding to the recognized entity, or a combination thereof.

Next, an associated searching may be performed, at step 1412, for obtaining one or more search results. The one or more search results are obtained based on matching of the one or more nodes of the activation graph with one or more nodes of the knowledge graph. Further, the method includes pre-processing the received text data by performing at least one of: tokenization, removal of stop words, removal of punctuation marks, and removal of spaces. Upon pre-processing, the method includes performing a direct searching by matching the pre-processed received text data with one or more nodes of the comprehensive knowledge graph for obtaining the one or more search results.

Thereafter, one or more ranked and selected search results may be rendered to the user, at step 1414. The one or more ranked and selected search results may include shortcuts to open a handwritten document associated with the search results, online links associated with the search results, or a combination thereof. The search results may be selected based on an accessibility level of the user and visibility level of the one or more nodes and their relationships.

In an embodiment of the present disclosure, the visibility level of the one or more nodes and their relationships may be automatically defined based on historical visibilities of nodes and their relationships. In another embodiment of the present disclosure, the visibility level of the one or more nodes and their relationships may be manually defined based on user inputs in a documents database.

In an embodiment of the present disclosure, based on the pre-defined visibility, the documents database includes one or more public documents corresponding to the documents publicly available to each user, one or more shared documents corresponding to the documents on a subject to which the user is invited, and one or more private documents corresponding to the documents that are specific to one user. The method ends at step 1416.

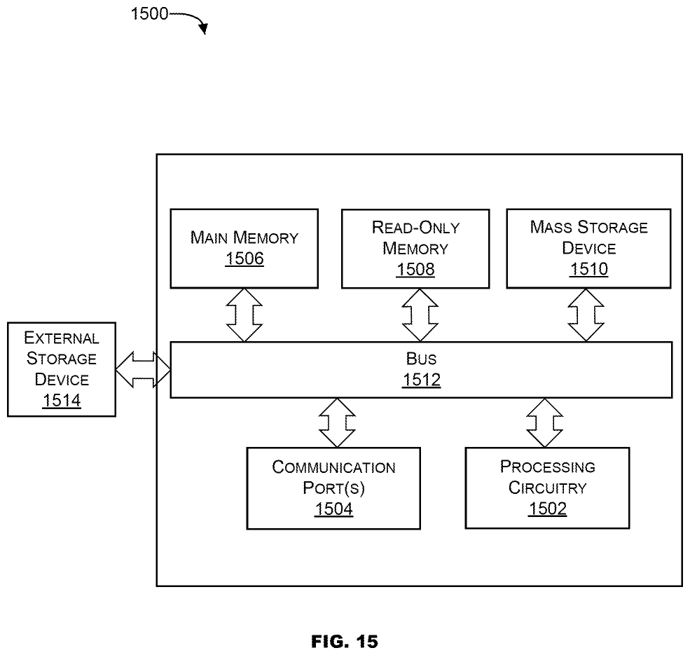

FIG. 15 illustrates an exemplary computer system in which or with which embodiments of the present disclosure may be utilized. As shown in FIG. 15, a computer system 1500 includes an external storage device 1502, a bus 1504, a main memory 1506, a read-only memory 1508, a mass storage device 1510, a communication port 1512, and a processor 1514.

Those skilled in the art will appreciate that computer system 1500 may include more than one processor 1514 and communication ports 1512. Examples of processor 1514 include, but are not limited to, an Intel® Itanium® or Itanium 2 processor(s), or AMD® Opteron® or Athlon MP® processor(s), Motorola® lines of processors, FortiSOC™ system on chip processors or other future processors. Processor 1514 may include various modules associated with embodiments of the present disclosure.

Communication port 1512 can be any of an RS-232 port for use with a modem-based dialup connection, a 10/100 Ethernet port, a Gigabit or 10 Gigabit port using copper or fiber, a serial port, a parallel port, or other existing or future ports. Communication port 1512 may be chosen depending on a network, such as a Local Area Network (LAN), Wide Area Network (WAN), or any network to which the computer system connects.

Memory 1506 can be Random Access Memory (RAM), or any other dynamic storage device commonly known in the art. Read-Only Memory 1508 can be any static storage device(s), e.g., but not limited to, a Programmable Read-Only Memory (PROM) chips for storing static information, e.g., start-up or BIOS instructions for processor 1514.

Mass storage 1510 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g., those available from Seagate (e.g., the Seagate Barracuda 7200 family) or Hitachi (e.g., the Hitachi Deskstar 7K1000), one or more optical discs, Redundant Array of Independent Disks (RAID) storage, e.g., an array of disks (e.g., SATA arrays), available from various vendors including Dot Hill Systems Corp., LaCie, Nexsan Technologies, Inc. and Enhance Technology, Inc.

Bus 1504 communicatively couples processor(s) 1514 with the other memory, storage, and communication blocks. Bus 1504 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1514 to a software system.

Optionally, operator and administrative interfaces, e.g., a display, keyboard, and a cursor control device, may also be coupled to bus 1504 to support direct operator interaction with the computer system. Other operator and administrative interfaces can be provided through network connections connected through communication port 1512. An external storage device 1502 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure.

Thus, it will be appreciated by those of ordinary skill in the art that the diagrams, schematics, illustrations, and the like represent conceptual views or processes illustrating systems and methods embodying this disclosure. The functions of the various elements shown in the FIGURES may be provided through the use of dedicated hardware as well as hardware capable of executing associated software. Similarly, any switches shown in the FIGURES are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

1. A system for building a knowledge graph from handwritten document, the system comprising:
a receiver module configured to receive a handwritten document along with dynamic handwritten data from an electronic device;
a recognition module configured to recognize a plurality of potential terms for one or more objects in the handwritten document by employing a handwriting recognition technique, wherein the plurality of potential terms for each of the one or more objects includes a closest recognized term and at least one alternative recognized term;
a concept building module configured to:
determine one or more conceptual terms from one or more potential recognized terms of the plurality of potential terms; and
determine a multi-level relation between one or more potential recognized terms, out of the plurality of potential terms, and the handwritten document; and
a knowledge graph building module configured to build a knowledge graph, wherein the knowledge graph is built based at least on one of: the plurality of potential terms, the one or more conceptual terms, the determined multi-level relation between the one or more potential recognized terms and the handwritten document,
wherein the knowledge graph is used to enable at least a semantic searching of one or more handwritten documents.

2. The system of claim 1, wherein the dynamic handwritten data is received in the form of one or more tuples having at least one of: data on x-axis, data on y-axis, pressure, speed of writing, or orientation.

3. The system of claim 2, wherein the handwriting recognition techniques analyze each of the received one or more tuples to identify the closest recognized term along with one or more alternative recognized terms that each of the received one or more tuples potentially represents.

4. The system of claim 1, wherein the concept building module is configured to perform a named entity linking on the plurality of potential terms to determine the corresponding one or more conceptual terms.

5. The system of claim 1, wherein the one or more conceptual terms include at least one of: terms corresponding to the recognized text in one or more languages, one or more synonym terms corresponding to the recognized text, one or more abbreviation terms corresponding to the recognized text, or one or more internally defined terms corresponding to the recognized text.

6. The system of claim 1, wherein each of the plurality of potential terms along with the one or more corresponding conceptual terms are placed as a node in the built knowledge graph, such that one node is connected to another node based on the determined multi-level relation between the corresponding potential recognized terms and the handwritten document.

7. The system of claim 1, wherein the knowledge graph building module is further configured to facilitate the user to set visibility of newly added nodes and their relationships in the knowledge graph.

8. The system of claim 1, wherein the knowledge graph building module is further configured to automatically set visibility of newly added nodes and their relationships in the knowledge graph based on historical visibilities of nodes and their relationships.

9. The system of claim 8, wherein based on the set visibility, the one or more nodes and their relationships are divided into at least one of: one or more public nodes and relationships corresponding to the documents publicly available to each user, one or more shared nodes and relationships corresponding to the documents on a subject to which the user is invited, and one or more private nodes and relationships corresponding to the documents that are specific to one user.

10. A method for building a knowledge graph from handwritten documents, the method comprising:
receiving a handwritten document along with dynamic handwritten data from an electronic device;
recognizing a plurality of potential terms for one or more objects in the handwritten document by employing a handwriting recognition technique, wherein the plurality of potential terms for each of the one or more objects includes a closest recognized term and at least one alternative recognized term;
determining one or more conceptual terms from one or more potential recognized terms of the plurality of potential terms;
determining a multi-level relation between one or more potential recognized terms, out of the plurality of potential terms, and the handwritten document; and
building a knowledge graph, wherein the knowledge graph is built based at least on one of: the plurality of potential terms, the one or more conceptual terms, and the determined multi-level relation between the one or more potential recognized terms and the handwritten document,
wherein the knowledge graph is used to enable at least a semantic searching of the one or more handwritten documents.

11. The method of claim 10, wherein the handwriting recognition techniques analyze each of received one or more tuples to identify the closest recognized term along with one or more alternative recognized terms that each of the received one or more tuples potentially represents.

12. The method of claim 10, which further comprises performing a named entity linking on the plurality of potential terms to determine the corresponding one or more conceptual terms.

13. The method of claim 10, wherein each of the plurality of potential terms along with the one or more corresponding conceptual terms are placed as a node in the built knowledge graph, such that one node is connected to another node based on the determined multi-level relation between the corresponding potential recognized terms and the handwritten document.

14. The method of claim 10, which further comprises facilitating the user to set visibility of the one or more newly added nodes and their relationships in the knowledge graph.

15. The method of claim 10, which further comprises automatically setting visibility of the one or more newly added nodes and their relationships in the knowledge graph based on historical visibilities of nodes and their relationships.

16. A semantic searching system for searching handwritten documents using a knowledge graph, the semantic searching system comprising:
a receiver module configured to receive, from an electronic device, text data having one or more terms associated with a user's intended search;
an entity recognition module configured to perform entity recognition from the text data to determine one or more entities present in the text data;
a concept determination module configured to determine one or more conceptual terms for each of the determined one or more entities via a named entity linking;
an activation graph creation module configured to create an activation graph based on the determined one or more conceptual terms by adding nodes and their relationships corresponding to at least of: terms corresponding to the recognized entity in one or more languages, one or more synonym terms corresponding to the recognized entity, one or more abbreviation terms corresponding to the recognized entity, or one or more internally defined terms corresponding to the recognized entity;
an associative searching module configured to perform an associated searching for obtaining one or more search results based on matching of the one or more nodes of the activation graph with one or more nodes of the knowledge graph; and
a rendering module configured to render ranked and selected search results to the user,
wherein the one or more ranked and selected search results include at least one of: shortcuts to open a handwritten document associated with the search results, or online links associated with the search results.

17. The semantic searching system of claim 16, wherein the associative searching module selects the search results based on an accessibility level of the user and visibility level of the one or more nodes and their relationships.

18. The semantic searching system of claim 16, wherein the visibility level of the one or more nodes and their relationships is at least one of: automatically defined based on historical visibilities of nodes and their relationships, or manually defined based on user inputs in a documents database.

19. The semantic searching system of claim 18, wherein based on the pre-defined visibility, the documents database includes at least: one or more public documents corresponding to the documents publicly available to each user, one or more shared documents corresponding to the documents on a subject to which the user is invited, and one or more private documents corresponding to the documents that are specific to one user.

20. The semantic searching system of claim 16, which further comprises a direct searching module configured to:
pre-process the received text data by performing at least one of: tokenization, removal of stop words, removal of punctuation marks, or removal of spaces; and
perform a direct searching by matching the pre-processed received text data with one or more nodes of the comprehensive knowledge graph for obtaining the one or more search results.
